(19) United States
(12) Patent Application Publication
(10) Pub. No.: US 2017/0190559 A1
(43) Pub. Date: Jul. 6, 2017

(54) BAR SYSTEM AND METHOD FOR SIMULTANEOUSLY POURING BEER INTO A PLURALITY OF GLASSES

(71) Applicant: BEERJET GMBH, St. Florian bei Linz (AT)

(72) Inventors: Ernst KOLLER, Bad Leonfelden (AT); Thomas SCHULLER, Weyer (AT); Markus WEIGL, Wieselburg an der Erlauf (AT); Ludwig KLEINLEHNER, Reinsberg (AT)

(73) Assignee: BEERJET GMBH, St. Florian bei Linz (AT)

(21) Appl. No.: 15/321,437

(22) PCT Filed: Jan. 15, 2015
(86) PCT No.: PCT/AT2015/050014

§ 371 Date: Dec. 22, 2016

(30) Foreign Application Priority Data
Feb. 5, 2014 (AT) A 50086/2014

(51) Int. Cl. B67D 1/12; B67D 1/02; B67D 1/00; B67D 1/08

(52) U.S. Cl. CPC B67D 1/1272; B67D 1/08; B67D 1/025; B67D 1/0009; B67D 1/127; B67D 2210/00068

(57) ABSTRACT

The invention relates to a bar system (1) for simultaneously pouring beer (3) from a reservoir (2) into a plurality of containers such as glasses (4), comprising a supply line (5) having an adjoining distributor region (6) having a plurality of outlets (7), wherein the beer (3) can be conducted via the supply line (5) into the distributor region (6) and via the latter into the containers such as glasses (4). In order to fill the containers such as glasses (4) uniformly with beer (3) and with a head of foam of equal height, it is possible according to the invention to till the distributor region (6) completely with beer (3) when the supply line (5) is partially full. The invention further relates to a method for simultaneously pouring beer (3) into a plurality of containers such as glasses (4), the beer (3) being conducted from a reservoir (2) for the beer (3) via a supply line (5) to a distributor region (6) having a plurality of outlets (7) and the beer (3) being discharged via the outlets (7) and taps into the containers such as glasses (4). According to the invention the beer (3) is guided from a reservoir (2) via a supply line (5), partially filling said supply line, into the distributor region (6), completely tilling said distributor region, and the beer (3) is poured when the distributor region (6) is full.

The invention relates to a bar system for simultaneously pouring beer from a reservoir into a plurality of containers such as glasses, comprising a supply line having an adjoining distributor region with a plurality of outlets, wherein the beer can be conducted via the supply line into the distributor region and via said distributor region into the containers such as glasses.

Furthermore, the invention relates to a method for simultaneously pouring beer into a plurality of containers such as glasses, wherein the beer is conducted from a reservoir for the beer via a supply line to a distributor region having a plurality of outlets, and wherein the beer is dispensed via the outlets and taps into the containers such as glasses.

In the food service industry, bar systems with different designs are used for serving beverages, in particular carbonated beverages such as beer, for example. For this purpose, bar systems which can be used to fill drinking containers in a semi-automated or automated manner are also known.

Known bar systems normally comprise a bar computer that controls a pouring operation. After an actuation of a button by the serving staff, a main valve in the selected tap is opened, which valve releases the flow of a beverage. The beverage then flows out of a supply container or reservoir, through a feed line and the selected tap into a drinking container. Once a desired amount is reached or the drinking container is full, the valve is closed and the pouring operation is ended. A serving amount is typically set by means of a time or quantity control. In the case of a quantity control, a flow meter is for example provided to measure a flow mass, wherein the flow meter is connected to the bar computer. The bar computer thus receives current information about the poured beverage quantity and can thus control the pouring operation.

At large events with several thousand people, such as open-air concerts, at least a few hundred people must often be served beverages simultaneously within a short time. In order to meet this demand, what is referred to as pre-pouring begins roughly an hour before the arrival of visitors. During pre-pouring, approximately 80% of the filling quantity is poured into the glasses, so that more than 1,000 glasses are quickly available and the head of foam is only formed by an additional brief feed. During operation, continuous serving then occurs by means of what is referred to as final pouring (pour plus head of foam).

Existing bar systems for serving at large events regulate an amount of the beverage being dispensed using a till system, but the rate is very slow. Although faster systems are also known, these systems have a low degree of automation. These faster systems comprise a tank, a relatively thick line and a rapid tap with no regulation. Pouring must be performed manually by a master pourer. Even if a master pourer has an appropriate routine, pouring beer into glasses with a consistent head of foam is in this manner not possible or hardly possible.

To the extent that semi-automated or automated bar systems have been used up to now, these systems operate slowly, as approximately ten seconds are required to fill up a glass. This is adequate for pre-pouring under ideal conditions, since ample time is available therefor, but not for final pouring. For final pouring, a target of three to four seconds per pouring operation should be achieved.

In the context of the invention, it was found that a plurality of parameters which interact with one another are to be considered to meet the criteria of a high pouring capacity or rapid filling of glasses while forming a consistently high foam head of the beer in the glasses. These especially include the pressure to which the beer is subjected, the temperature of the beer, and the supply of CO₂. These parameters can in particular also influence a pouring rate in the course of operation. If these parameters change, a bar system must therefore be occasionally recalibrated in a relatively costly manner. In the case of automated bar systems, there is also the problem that the individual taps typically have a different pouring rate. The glass that is filled at the highest pouring rate due to the proximity to the supply line may therefore already be overflowing while a different glass that is located farther away from the supply line and is thus filled from a tap with a lower pouring rate is only half full. The pouring rate or a flow rate of individual taps can be matched to one another, but costly calibration work is necessary to do so, particularly if the pouring rate also changes in the course of operation as explained above.

According to the prior art, attempts have been made to create automated bar systems which are intended to enable rapid pouring. In DE 10 2010 044 550 A1, a bar system with a distributor having a plurality of outlets is disclosed. A pressure compensation chamber is arranged above the distributor, which chamber acts as a damper during the opening or closing of stop valves and is thus intended to enable faster pouring. However, it has been shown that this system can in any case be used at higher pressures on the beer of approximately 3 bar, but then also results in increased foam formation due to the stronger pressure. To avoid this increased foam formation, the pouring rate must ultimately be restricted. The aforementioned higher pouring rates, in particular targets of three to four seconds for filling glasses with a volume of one-half liter, are therefore not attainable.

The object of the invention is to specify a bar system of the type named at the outset with which a plurality of glasses can be simultaneously filled with beer within a short time, wherein the glasses can be filled uniformly and with a head of foam of largely equal height.

Furthermore, the object of the invention is to specify a method with which a plurality of glasses can be rapidly filled with beer and with the formation of a head of foam of approximately equal height.

For a bar system of the type named at the outset, the object of the invention is attained in that the distributor region can be completely filled with beer when the supply line is partially filled.

One advantage of a bar system according to the invention can be seen in that a plurality of glasses or other containers, such as cups, can be simultaneously filled with beer, wherein despite the plurality of glasses the beer is of equal height and is poured with a head of foam of essentially equal height. At the same time, a pouring rate for all glasses is for the most part consistent, so that no overflowing and thus also no loss of beer occurs as a result of different pouring rates. These effects are achieved by a partial filling of the supply line on the one hand, and by a complete filling of the distributor region while maintaining this state by a consistent backfeed of beer from the supply line. Along the supply line, which is only partially full, the foam is effectively separated from the liquid. This is particularly advantageous in the case of highly agitated beer, as a uniform foam head formation would otherwise not be possible. The liquid separated from the foam is subsequently supplied to the distributor region, so that foam-free beer is available for pouring. It thus becomes possible, to form a uniform head of foam in all glasses starting from the foam-free beer in the distributor region. In addition, a high pouring rate is ensured. Since the distributor region is completely filled, different pouring rates are also avoided for the most part, whereby a loss of beer due to a glass overflowing is prevented.

A connection between the supply line and distributor region, wherein the supply line can be filled only partially with beer, but the distributor region can be filled completely with beer, can take place in different ways. For example, it is possible that, at a connection point of the distributor region to the supply line, a pump is provided with which the beer liquid that is separated from the foam is pumped from the supply line into the distributor region. Another possibility is that, between the supply line and the distributor region, a non-return valve is arranged so that, at a sufficiently high pressure, the distributor region is constantly filled with beer. A further connection possibility is that the supply line and the distributor region are embodied as communicating vessels, wherein a connection leads from the liquid region in the supply line to the distributor region, and a highest level of the liquid in the distributor region lies below a lowest level of the liquid in the supply line.

An embodiment with a particularly simple design results if the supply line opens into the distributor region at an upper part of the distributor region, in particular at a highest point of the distributor region. It is thus possible to constantly keep the distributor completely filled with beer in a simple manner and without additional technical measures. For this purpose, it is expedient that the supply line is arranged in connection with the distributor region above said distributor region. The beer can then be conducted downwards into the distributor region from above via the supply line, so that the distributor region is constantly filled with beer. If the supply line is embodied with a longitudinal extension, a demixing of foam and beer liquid can also occur at the same time in a simple design during a feed of the beer into the distributor region when the supply line is partially full, as a result of which optimal conditions for a subsequent pouring of the beer from the distributor region are created.

To achieve a most suitable possible demixing of foam and beer liquid, it can be provided that the supply line is embodied with a longitudinal extension which corresponds to at least a longitudinal extension of the distributor region. With this measure, an adequately long distance is provided along which the desired separation of the foam from the liquid of the beer can occur. This is particularly important if beer is to be poured from newly delivered kegs or tanks, since this beer normally is not settled or is agitated as a result of transport.

In particular, it can be provided that the supply line is embodied in connection with the distributor region with a part connecting vertically to the distributor region and a longitudinally extended part connecting thereto which is preferably arranged horizontally. The supply line and the distributor region can then be embodied in a tubular manner. This results in a particularly simple technical design for achieving a high pouring rate with a simultaneously optimal appearance of the poured beer in the glasses and a minimization of the loss of beer due to different pouring rates.

To further homogenize the pouring process, a pressure compensation vessel with a gas supply for applying a gas to the pressure compensation vessel can be provided, wherein the pressure compensation vessel is connected to the supply line with gas exchange taking place. A high pouring rate can thus still be obtained without a loss in quality even if the beer is backfed slowly.

The pressure compensation vessel can in principle be arranged at any desired positions in the bar system, since the gas can be fed to the supply line via a pressure line without significant technical problems. However, it is preferred that the pressure compensation vessel is arranged above the supply line. This allows a compact design, since the pressure compensation vessel, supply line and distributor region can be positioned one on top of the other. In particular, these components can be arranged one on top of the other on a plane, so that a space-saving setup results.

The pressure compensation vessel can, like the supply line and the distributor region, be embodied in a tubular manner or as a tube. If all three components are embodied in a tubular manner, they can be connected using a vertical tube, so that design work for the bar system is minimized.

The distributor region is expediently equipped with a number of taps equaling a number of the outlets. Here, it is advantageous that openings of the taps are positioned above a maximum level of a beer in the distributor region. The beer is then fed into a tap from below, which is advantageous with regard to the optimal formation of a head of foam.

Switching valves can also be provided in the taps in order to rinse the taps with water as needed. During operation of a bar system according to the invention, the beer can be left in the supply line during an interruption in the serving operation (for example, at night), since CO₂ is applied to the beer in any case by the pressure compensation vessel and the beer therefore does not suffer a reduction in quality. In the taps in which residual beer remains, however, hygienic problems can occur over time. If a switching valve is provided, the tap can easily be rinsed with water and thus cleaned after completion of a pouring operation. In addition, it is also possible that corresponding cleaning procedures are logged by a bar computer, so that the proper operation of a bar system can also be documented.

In a further embodiment, the bar system can comprise a rotatable and raisable lifting device for the glasses. With a lifting device that is both raisable and also rotatable, pouring into glasses or cups of differing glass or cup heights, respectively, can occur in that an adjustment is made by means of a suitable upwards or downwards travel of a surface for the containers. Additionally, even better control is ensured during the pouring operation. By raising the containers and pivoting the same, the ends of the taps can reach far into said containers, so that the ends of the taps are initially positioned just above a base of the container that is to be filled. During pouring, the containers are lowered so that a consistently small distance between the end of the tap or tap line and the fill level in the container can be maintained. Only at the end of the foam-free pour is the lifting device pivoted into the horizontal position of the containers and lowered in order to create a larger clear distance between the tap line and the fill level and to thus form the head of foam. The rotating mechanism and the pivoting mechanism are embodied such that they can be actuated simultaneously. In this manner, the containers can be moved along any desired lifting and pivoting paths.

To calculate and control an optimal pour, the bar system can be equipped with an industrial computer having an integrated PLC control. Via the control, an optimal flow rate can be controlled in order to achieve the same pouring time and foam formation even in the case of pressure differences.

Apart from this, it can also be provided that the supply line and the distributor region are partially or completely encased by profiles of a metal. For this purpose, specifically profiles of aluminum or an aluminum alloy are used, preferably die-cast profiles of these materials. The profiles are embodied in a hollow manner, and a cooling medium can be applied thereto in order to keep a temperature of the beer constant at approximately 4° C. Thus, in contrast to the prior art, according to which a costly wrapping with copper pipes occurs, the beer temperature is kept at a desired value in a simple manner.

The method-related object of the invention is attained in that, in a method of the type named at the outset, the beer is conducted from a reservoir via a supply line, partially filling said supply line, into the distributor region, completely filling said distributor region, and the beer is poured when the distributor region is full.

One advantage achieved by the method according to the invention can be seen in that, due to the only partial filling of the supply line but the simultaneous complete filling of the distributor region, beer can be poured into a plurality of glasses at a high pouring rate and with an optimal or uniform formation of a head of foam in the individual glasses. Along the supply line, which is only partially filled, for example at a fill level of 20% to 90%, a settling of the supplied beer takes place. During this settling, the foam separates from the liquid of the beer, as a result of which virtually pure liquid can be conducted into the distributor region. The distributor region is completely filled, so that an equal pouring rate is ensured for the individual outlets even if all outlets are operated at the same time. As a result of these combined measures, not only is the beer poured into the individual glasses at an equal rate, but also at a high pouring rate with the formation of a head of foam of essentially equal height.

For the complete filling of the distributor region in a simple manner, it is advantageous if the beer is introduced into the distributor region at a highest point thereof.

A complete filling of the distributor region can be achieved in a particularly simple manner if the beer is conducted into the distributor region from above via a tubular connector while partially filling the supply line.

For a settling of the beer or an effective separation of the foam from the liquid of the beer, it can be provided that the beer is conducted along a preferably horizontally embodied part of the supply line while partially filling said supply line, and subsequently conducted downward to the distributor region in another part.

A fill level in the supply line can in principle be chosen as desired, provided that a filling of said supply line is not complete and a volume for the foam that is to be separated is thus available. It is expedient that the beer is conducted in a region of the supply line arranged upstream of the distributor region at a fill level of maximally 80%, preferably maximally 60%.

For a uniform filling of the glasses at a fluctuating backfeed rate of the beer, for example in the case of a low fill level in a tank serving as a reservoir, pressure fluctuations occurring during pouring can be compensated by applying gas from a pressure compensation vessel to the supply line. Here, it can in particular be provided that the gas is supplied from a pressure compensation vessel arranged above the supply line, so that the method can be implemented with a compact bar system.

In addition, it can be provided that the containers such as glasses are moved vertically and pivoted in a controlled manner during pouring. In this manner, the method can be further improved with regard to an optimal filling of the containers and a formation of a head of foam. The glasses are then initially pivoted and moved downward during filling, so that a constant distance between the tap line and fill level is continuously ensured in the container. For the formation of a head of foam, the container is then positioned vertically and lowered at a predetermined fill level.

To attain consistent temperatures of poured beer, the supply line and the distributor region can be cooled with a liquid cooling medium. This can be achieved, for example, if the cooling medium is conducted through metal profiles adjoining the supply line and the distributor region.

Additional advantages, features and effects of the invention follow from the exemplary embodiment described below. The drawings which are thereby referenced show the following:

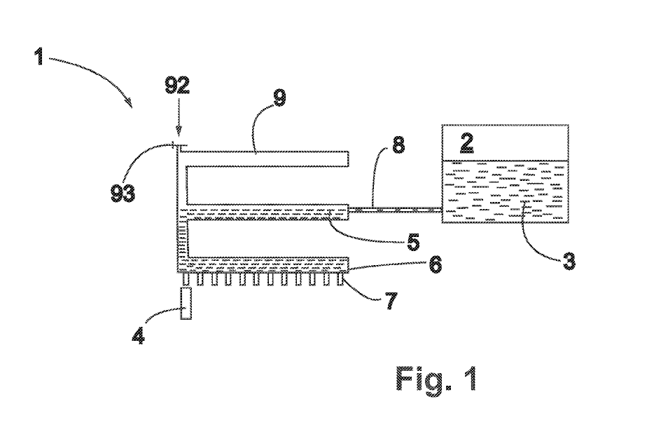

FIG. 1 A schematic illustration of the concept according to the invention;

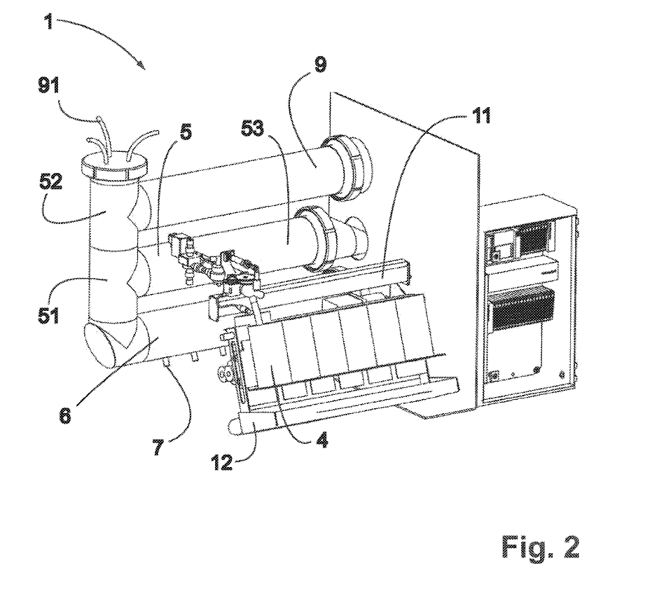

FIG. 2 A part of a bar system according to the invention;

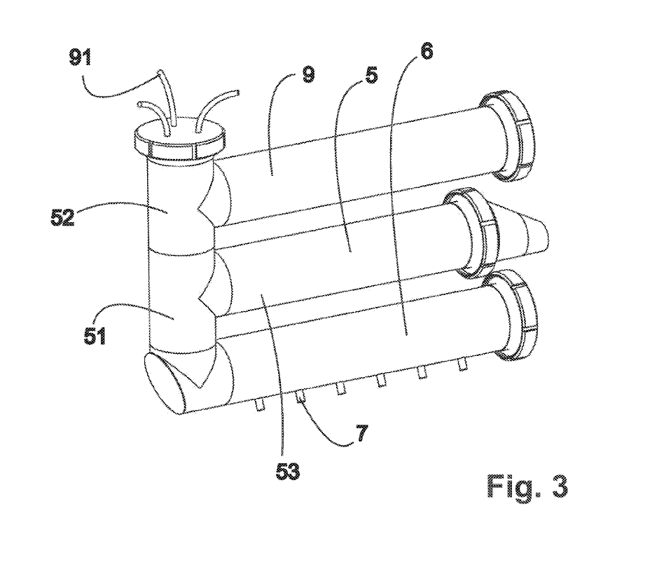

FIG. 3 A tubular arrangement with a pressure compensation vessel, supply line and distributor region;

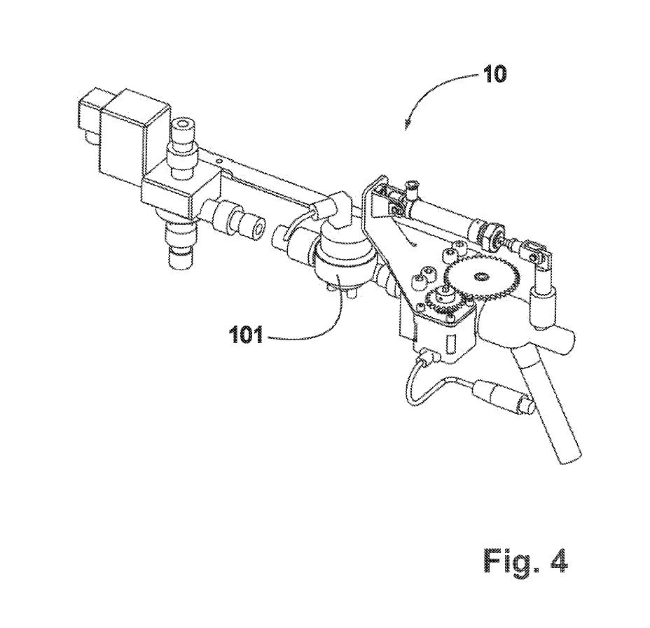

FIG. 4 A tap;

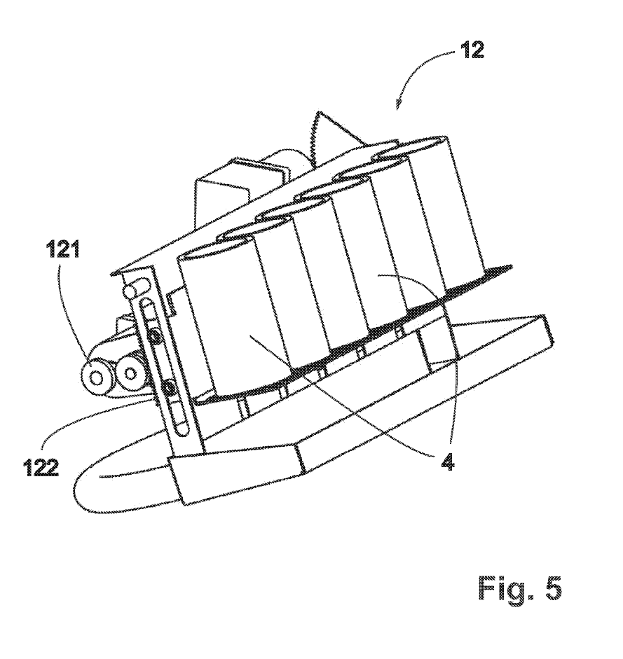

FIG. 5 A lifting device for glasses;

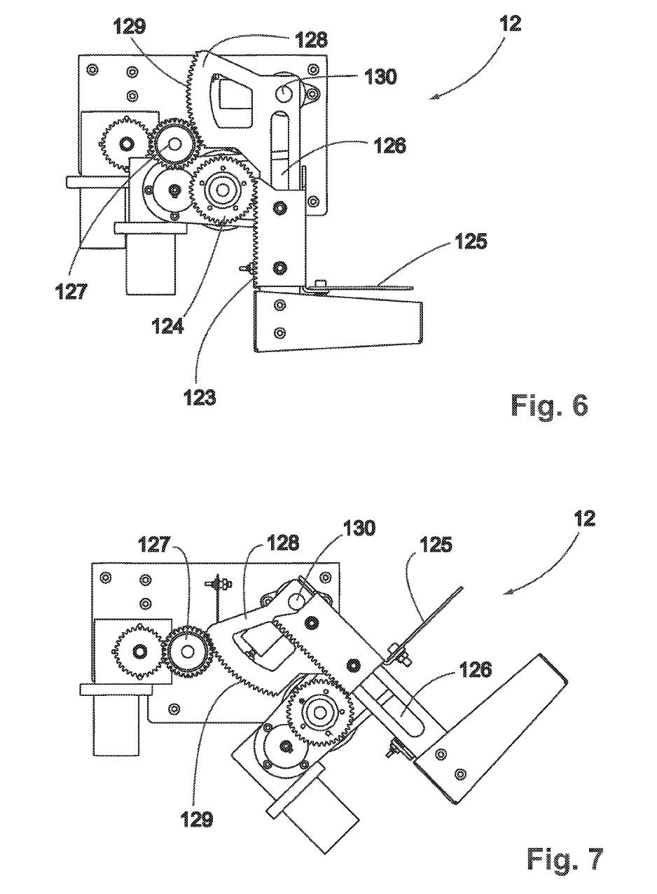

FIG. 6 A side view of the lifting device according to FIG. 5 in a first position;

FIG. 7 A further side view of the lifting device according to FIG. 5 in a second position;

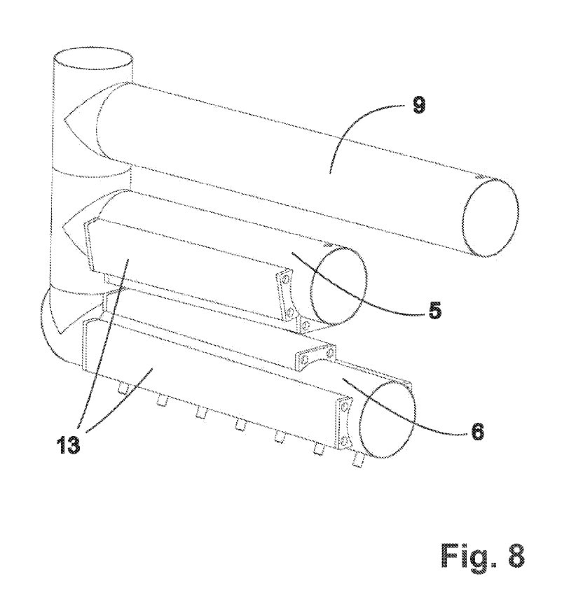

FIG. 8 A section of an arrangement according to FIG. 3 with additional cooling profiles.

In FIG. 1, a method according to the invention using a bar system 1 according to the invention is drawn in a highly schematic manner. The bar system 1 comprises a reservoir 2 in which a supply of beer 3 is stored. The reservoir 2 can be a keg or a tank. Particularly for large events, large-volume tanks are used more frequently than kegs. It is also possible that the reservoir 2 is formed from a plurality of kegs, from which beer 3 can be withdrawn selectively. This can be achieved, for example, by the use of a plurality of switchable valves. The bar system 1 is connected to the reservoir 2 via a line 8. In the bar system 1, the line 8 opens into a wider supply line 5. This supply line 5 runs further to a distributor region 6 having a plurality of outlets 7. As illustrated, the supply line 5 is preferably arranged above the distributor region 6, so that backfed beer 3 constantly fills the distributor region 6 completely while partially filling the supply line 5. However, it is also possible that the supply line 5 is arranged at the same height as or below the distributor region 6, as long as means are provided which allow a complete filling of the distributor region 6 with a partial filling of the supply line 5, for example pumps or other means of conveyance. Furthermore, a pressure compensation vessel 9 having a plurality of connections is provided. The pressure compensation vessel 9 is connected to a gas reservoir, and a gas, particularly CO₂, can be applied thereto at a predefined and controllable pressure. The pressure compensation vessel 9 can be arranged at any desired positions, but is advantageously located above the supply line 5. During operation, the beer 3 is conducted from the reservoir 2 to the supply line 5 via the line 8. In the supply line 5, which is embodied with a diameter of approximately 5 cm to 25 cm, specifically 10 cm to 20 cm, a flow rate of the beer 3 is low as a result of the large, and in particular considerably larger compared to a cross section of the line 8, cross section. The beer 3 is backfed into this region such that the region is not completely filled. Typically, fill levels in the supply line 5 of approximately 30% to 70% are present during operation. As noted, the beer 3 flows relatively slowly and smoothly along the supply line 5, which has a length of at least 40 cm, so that foam can be separated from the liquid of the beer 3 along this settling distance. In this manner, a proper separation of foam and liquid is achieved in this region, which particularly in the case of highly agitated beer is advantageous. Depending on the design of the bar system 1, however, a shorter supply line 5 can also be used, wherein minimal lengths of 20 cm or more have proven expedient. In a downward direction, the supply line 5 ends in an upper level of the distributor region 6, so that the distributor region remains completely or at least for the most part completely full during a continuous backfeed of the beer 3, even in the case of a rapid pouring via the outlets 7. By means of this backfeeding of the beer 3 via the supply line 5, which has a settling effect for the beer 3, and the subsequent conducting of the beer 3 into a full distributor region 6, a high pouring rate can be attained, wherein consistent conditions are ensured along the plurality of outlets 7. Thus, even during a use or filling of a plurality of glasses 4, a consistently high level of liquid with a head of foam of likewise consistent height can be attained at all times. In order to also keep these effects constant during fluctuations in the beer backfeed, gas from the pressure compensation vessel 9 is also applied to the supply line 5, wherein pressures of 1.2 bar to 2.0 bar are typically used. For this purpose, gas 92 can be introduced into the pressure compensation vessel 9 via an opening which can be closed off by a valve 93. Because the beer 3 is conducted while partially filling the supply line 5 and while simultaneous filling the distributor region 6, however, a relatively low pressure of approximately 1.3 bar to 1.6 bar can normally be used for operation. Since only a slight application of pressure is required, the conditions for the simultaneous formation of heads of foam in a plurality of glasses 4 is further optimized, as the foam head formation proceeds in a considerably more defined manner at lower pressure than at high pressure.

In FIG. 2, a section of a bar system according to the invention is illustrated as an exemplary embodiment. The part of the bar system 1 shown comprises a supply line 5 and a distributor region 6 arranged below said supply line and a pressure compensation vessel 9 arranged above said supply line. The indicated elements, which are illustrated separately in FIG. 3, are all embodied in a tubular manner or are formed from tube sections. The pressure compensation vessel 9 is embodied with connections 91 to be able to conduct a gas into the pressure compensation vessel 9 or to apply pressure to said vessel. At the end opposite the outlets 9, the pressure compensation vessel is sealed in a gas-tight manner. The supply line 5 positioned therebelow is embodied at one end with parts 51, 52 running upwards and downwards which connect to a horizontally positioned longitudinally extended part 53. Thus, a connection to the pressure compensation vessel 9 is produced in the upward direction. In the downward direction, the part 51 of the supply line 5 opens into the distributor region 6, which is sealed at an opposite end. A position of the inlet into the distributor region 6 is thereby chosen such that, when beer 3 is conducted in the supply line 5, the distributor region 6 is automatically filled, since a lowest level of the supply line 5 is always above an uppermost level of the distributor region 6. Thus, even in the case of a fluctuating beer backfeed or varying flow rates, there is always enough beer available in the distributor region 6 to be poured rapidly or at a high rate. The three elements operatively connected to one another, the supply line 5, distributor region 6 and pressure compensation vessel 9, are arranged one above the other on a plane, so that a compact design for a rapid pouring of beer into a plurality of glasses 4 results.

Furthermore, the bar system comprises multiple taps 10 having switching valves 101 according to FIG. 4, of which taps only one is illustrated in FIG. 2. The taps 10 are mounted on a cross brace 11. The taps 10 are connected respectively to one of the outlets 7 via lines which are not illustrated, so that the beer 3 is supplied from below when it is conveyed to the tap 10, which has also proven advantageous for a uniform filling of glasses 4.

For pouring into glasses 4, a lifting device 12 illustrated separately in FIG. 5 is also provided on which on the one hand a plurality of glasses 4 can be positioned and with which on the other hand during operation or pouring the glasses 4 can initially be raised and then, after reaching a certain fill level, tilted to form a head of foam. For this purpose, the lifting device 12 is equipped with a suitable rotation mechanism 121 and a rack and pinion 122 for a linear movement or a travel, which can be seen in detail in FIGS. 6 and 7 in two side views for a first position and a second position. The travel is set by a toothed rack 123 and a toothed wheel 124 which interacts therewith. For many applications, it is sufficient if a maximum travel is 10 cm. The toothed rack 123 runs perpendicular to a platform 125 for the glasses 4. In the first position (FIG. 6), the toothed wheel 124 is located at an uppermost point of the toothed rack 123 and is engaged therewith. If the toothed wheel 124 drives the toothed rack 123 upwards along a notch 126, the platform 125 thus also moves upwards. Furthermore, the rotating mechanism 121 is provided which can also be implemented as a rack and pinion, even if a pivot axis or other means for executing a rotational movement of the platform 125 may be provided. The rack and pinion comprises at least one toothed wheel 127 which is engaged with a leg 128 that connects to the notch 126 and has a curved toothed region 129 on the front face, and which produces a pivoting about a pivot axis 130 as a result of its curved shaping. The rotation mechanism 121 and the rack and pinion 122 can be actuated at the same time, so that lifting and pivoting can occur synchronously.

In FIG. 8, cooling elements for the supply line 5 and the distributor region 6 are illustrated. The cooling elements comprise one or more profiles 13 which are arranged around these elements. The cooling elements are normally formed from a metal, for example aluminum or an aluminum alloy, and a cooling medium can be applied thereto. An application of the cooling medium to the cooling elements or profiles 13 can, for example, occur by means of an external application of the cooling medium to the cooling elements. However, it is preferred that the profiles 13 are embodied in a hollow manner, so that a cooling medium can be conducted through the suitably thermoconducting metal profiles 13 via provided inlets and outlets. For this purpose, the profiles 13 can surround the supply line 5 and the distributor region 6 completely. However, provided that a desired cooling effect for these parts can also be achieved with a partial encasing by the profiles 13, it is sufficient that an encasing by the profiles 13 is only present in sections.

1. A bar system (1) for simultaneously pouring beer (3) from a reservoir (2) into a plurality of containers such as glasses (4), comprising a supply line (5) having an adjoining distributor region (6) with a plurality of outlets (7), wherein the beer (3) can be conducted via the supply line (5) into the distributor region (6) and via said distributor region into the containers such as glasses (4), characterized in that the supply line (5) is connected to the distributor region (6) such that the distributor region (6) is completely filled with beer (3) when the supply line (5) is partially filled.

2. The bar system (1) according to claim 1, characterized in that at an upper part of the distributor region (6), in particular at a highest point of the distributor region (6), the supply line (5) opens into said distributor region.

3. The bar system (1) according to claim 1, characterized in that the supply line (5) is arranged in connection with the distributor region (6) above said distributor region.

4. The bar system (1) according to claim 1, characterized in that the supply line (5) is embodied with a longitudinal extension.

5. The bar system (1) according to claim 1, characterized in that the supply line (5) is embodied with a longitudinal extension which corresponds to at least a longitudinal extension of the distributor region (6).

6. The bar system (1) according to claim 1, characterized in that the supply line (5) is embodied in connection with the distributor region (6) with a part (51) connecting vertically to the distributor region (6) and a longitudinally extended part (53) connecting to said part which is preferably arranged horizontally.

7. The bar system (1) according to claim 1, characterized in that the supply line (5) and the distributor region (6) are embodied in a tubular manner.

8. The bar system (1) according to claim 1, characterized in that a pressure compensation vessel (9) is provided with a gas supply for applying a gas to the pressure compensation vessel (9), and the pressure compensation vessel (9) is connected to the supply line (5) with gas exchange taking place.

9. The bar system (1) according to claim 8, characterized in that the pressure compensation vessel (9) is arranged above the supply line (5).

10. The bar system (1) according to claim 8, characterized in that the pressure compensation vessel (9) is embodied as a tube.

11. The bar system (1) according to claim 1, characterized in that the distributor region (6) is equipped with a number of taps (10) equaling a number of the outlets (7).

12. The bar system (1) according to claim 11, characterized in that openings of the taps (10) are positioned above a maximum level of the beer (3) in the distributor region (6).

13. The bar system (1) according to claim 11, characterized in that switching valves (101) are provided in the taps (10) in order to rinse the taps (10) with water as needed.

14. The bar system (1) according to claim 1, characterized in that a rotatable and raisable lifting device (11) for the glasses (4) is provided.

15. The bar system (1) according to claim 1, characterized in that the supply line (5) and the distributor region (6) are partially or completely encased by profiles (13) of a metal, in particular hollow profiles (13).

16. A method for simultaneously pouring beer (3) into a plurality of containers such as glasses (4), wherein the beer (3) is conducted from a reservoir (2) for the beer (3) via a supply line (5) to a distributor region (6) having multiple outlets (7), and wherein the beer (3) is dispensed via the outlets (7) and taps (10) into the containers such as glasses (4), characterized in that the beer (3) is introduced into the distributor region (6), completely filling said distributor region, from a supply line (5), partially filling said supply line, and the beer (3) is poured when the distributor region (6) is full.

17. The method according to claim 16, characterized in that at the highest point of the distributor region (6) the beer (3) is introduced into said distributor region.

18. The method according to claim 16, characterized in that the beer (3) is conducted into the distributor region (6) from above via a tubular connector while partially filling the supply line (5).

19. The method according to claim 16, characterized in that the beer (3), while partially filling the supply line (5), is conducted along a preferably horizontally embodied part (53) of said supply line and subsequently conducted downwards to the distributor region (6) in another part (51).

20. The method according to claim 16, characterized in that the beer (3) is conducted in a region of the supply line (5) arranged upstream of the distributor region (6) at a fill level of maximally 80%, preferably maximally 60%.

21. The method according to claim 16, characterized in that pressure fluctuations occurring during pouring are compensated by applying gas from a pressure compensation vessel (9) to the supply line (5).

22. The method according to claim 21, characterized in that the gas is supplied from a pressure compensation vessel (9) arranged above the supply line (5).

23. The method according to claim 16, characterized in that the containers such as glasses (4) are moved vertically and pivoted in a controlled manner during pouring.

24. The method according to claim 16, characterized in that the supply line (5) and the distributor region (6) are cooled with a liquid cooling medium.

25. The method according to claim 24, characterized in that the cooling medium is conducted through metal profiles (13) adjoining the supply line (5) and the distributor region (6).
